(19) United States
(12) Patent Application Publication
(10) Pub. No.: US 2010/0119929 A1
(43) Pub. Date: May 13, 2010

(54) ELECTRIC BATTERY COMPRISING HEAT TREATMENT MODULES COATED WITH A STRUCTURAL MATRIX

(75) Inventors: Fabien Gaben, Ecully (FR); Claude Beignet, Meudon (FR); Alain Douarre, Gif Sur Yvette (FR)

Correspondence Address: BACHMAN & LAPOINTE, P.C., 900 CHAPEL STREET, SUITE 1201, NEW HAVEN, CT, 06510, US

(73) Assignee: SOCIETE DE VEHICULES ELECTRIQUES, Paris (FR)

(21) Appl. No.: 12/596,452

(22) PCT Filed: Mar. 17, 2008
(86) PCT No.: PCT/FR08/00349

§ 371 Date: Oct. 19, 2009

(30) Foreign Application Priority Data
Apr. 19, 2007 (FR) 0702855

(51) Int. Cl. H01M 10/50

(52) U.S. Cl. 429/120

(57) ABSTRACT

An electric battery has a plurality of elements generating electrical energy. A system for the mechanical and thermal packaging of the elements includes a bed of thermal packaging fluid on which the elements are placed so as to leave a lateral space between the adjacent elements. The packaging system further includes a plurality of thermal packaging modules, each provided with a path for the fluid to flow between an upstream port and a downstream port, each flow path extending along a lateral space with the ports in fluid communication with the bed. The packaging system further includes a structural matrix made of a thermally conductive and electrically insulating polymer resin, the matrix filling the lateral spaces, at least partly encapsulating the generator elements and the packaging modules.

### BACKGROUND

(1) Field of the Invention

The invention relates to an electric battery which is particular intended for the traction of an electric motor vehicle, or hybrid i.e. comprising an electric engine for driving the drive wheels combined with a thermal drive engine of the same or possibly of other drive wheels.

(2) Prior Art

In order to guarantee the levels of power and energy required for the electric vehicle or hybrid vehicle applications, it is necessary to create batteries comprising a plurality of elements generating electrical power.

When these elements are charged and discharged, this results in the production of heat which, when it is not controlled, can have the effect of decreasing the life span of the elements, and even give rise in extreme conditions, to risks of thermal runaway for certain chemical compositions of elements, leading to the deterioration of the battery.

The power that a battery is able to provide depends on the balancing in power of the various elements as well as on their operating temperature. Indeed, the power that can be delivered by an element increases with the temperature and when there are differences in the levels of power available in each of the elements, for the same battery, then the battery is referred to as unbalanced. This unbalance substantially affects the performance of the battery in terms of life span as well as in terms of average energy density as the total power that a battery can delivery is always limited by the power of the least charged element, and the total charged power is moreover limited by the element with the highest charge.

These differences in the level of energy between the elements, causing the unbalance, can be caused either by differences between the electrical properties of the elements, or by variations in the operating temperature between these elements. When an element of a battery is less charged than the others, a risk of inversion can then occur for the low charge conditions.

Moreover, the chemical compositions of batteries of the Lithium-ion type are more or less stable. When they are stressed in extreme conditions, a thermal runaway can occur. For batteries of high dimensions which are necessary for vehicles that are predominately electric, this risk is critical, because if the thermal runaway of an element propagates to the entire battery, the power implied by this runaway becomes very high.

In order to optimise the performance and the life span of the batteries, heat treatment systems for the elements have therefore been incorporated into the batteries.

In particular, cooling systems have been proposed using a circulation of air as a cold source. Although much effort has been made to try to guarantee by this means a temperature distribution that is as homogenous as possible within the battery, it nevertheless remains that such systems do not ensure a homogenous cooling of the battery elements stressed in power, as is in particular the case in applications intended for electric and hybrid vehicles that can be connected to the electric network (plug-ins).

The thermal dissipation peaks are very high and are a function of the current densities and of their variations which, for particular applications, can reach very high values, in particular during phases of strong acceleration, regenerative braking, fast battery charging or motorway operation in electric mode.

For such conditions of use, the airflows needed to cool the battery elements can be achieved only to the detriment of significant separation of the elements.

These strong flows are used to offset the low heat exchange coefficients of the airflows on the battery elements, and give rise to acoustic and vibratory problems. The fans needed to ensure the flows making it possible to cool the batteries homogenously and effectively thus have dimensioning which is not compliant with the requirements of compactness and of energy savings for the electric vehicle application.

In order to improve the effectiveness of the cooling, and by the same be able to increase the volume energy density of the batteries, a circulation of a liquid has been proposed. In particular, the liquid can be provided to flow through plastic sockets which are arranged between the battery elements. These sockets are insulators and participate in the electrical insulation between elements.

However, the plastic pockets wherein are formed these sockets are poor heat conductors, in such a way that they must have a thickness that is as thin as possible in order to guarantee heat transfers that are more or less correct. This then results in that the thin walls are not adapted to the mechanical resistance of the elements in the battery.

Moreover, in the electric vehicle or hybrid application, the batteries according to prior art have a certain number of problems, in particular due to the increase in the degree of hybridisation of thermal vehicles which can go as far as a full electrification of the traction chain. In this case, the batteries are no longer used solely for assisting the vehicles in the phases of acceleration but also in providing for the displacement of the vehicle autonomously over distances that are more or less substantial.

The energy as well as the electrical power of the batteries must therefore be increased, which increases the durations of stress on the battery, as well as the currents and the average internal resistance. As such, the power and the thermal power emitted increase, and this even more so as the battery ages.

The cost of a battery depends primarily on the number of elements that it contains, i.e. in other terms, on its power. So, in order to reduce the impact of the cost of batteries in a vehicle, it is sought to use said batteries over the widest range of potential possible in order to extract maximum amount of power from them.

As we approach the limit potential values allowed, the internal resistance of the elements increases and their life span is decreased.

The high power levels required result in substantial and rapid rises in temperature of the battery elements which can induce temperature gradients between the surface and the interior of the latter, even between the elements of the same battery.

These temperature gradients appear substantially during the transitory phases corresponding to the high inrush current, during charging or discharging.

The increase in the temperature within a battery element induces risks in terms of safety and life span, linked to the possible presence of hot points at the core of the element.

Still in reference to the safety of the batteries, it becomes even more critical with the increase in the power of the batteries, and the plastic sockets generally used for the circulation of a cooling liquid between the elements are likely to break under the effect of impacts of the type of those encountered during a vehicle crash, or via excessive pressure generated on the cooling circuit.

Such ruptures thus render the cooling system totally inoperable, but still worse, the liquid risks to short-circuit all of the battery elements, and as such create a real risk of fire, and even explosion.

### SUMMARY OF THE INVENTION

This invention therefore aims to perfect the existing electric batteries by proposing a heat and mechanical treatment system which makes it possible to substantially improve the ratio between the volume and the energy and/or the power, as well as the life span and the safety of the battery from a chemical performance standpoint as well as concerning the constraints in effect in the automobile industry, and in particular those concerning the crash.

The invention makes it possible to achieve levels of compactness of the system by responding to the requirements of volume energy density and power compatibles with the needs of the automobile application, at least cost and weight.

Furthermore, the very low heat transfer resistances possible thanks to the invention make it possible to guarantee the cooling of the battery despite the very high level of compactness. The invention also makes it possible to reduce the temperature within the elements during peaks of inrush current, and prevents any risk of direct electrical contact of the elements in the event of an impact, which is an advantage in terms of battery safety.

Finally, the effectiveness of the heat management makes it possible to reduce the electricity consumption and as such guarantee increased autonomy for the electric vehicle.

To this effect, the invention proposes an electric battery comprising a plurality of elements generating electrical power and a heat and mechanical treatment system of said elements, said system comprising a bed of heat treatment fluid whereon said elements are arranged in such a way as to allow a lateral separation between the adjacent elements, said treatment system further comprising a plurality of heat treatment modules which each provided with a path of travel of the fluid between an upstream port and a downstream port, each path of travel extending in a lateral separation with the ports in fluid communication with said bed, said treatment system further comprising a structural matrix made of heat conducting and electric insulation polymer resin, said matrix filling the lateral separations by coating at least partially said generating elements and said treatment modules.

### BRIEF DESCRIPTION OF THE DRAWINGS

Other particularities and advantages of the invention shall appear in the description which follows, made in reference to the attached figures wherein:

FIG. 1 is a perspective view of a portion of an electric battery according to a first embodiment;

FIG. 2 is a perspective view of a heat treatment module of the electric battery according to FIG. 1;

FIG. 3 are partial views of the electric battery according to FIG. 1, showing the connection of the modules in the bed of water respectively in a perspective (FIG. 3a) and in longitudinal section (FIG. 3b);

FIGS. 4 are views of a portion of an electric battery according to a second embodiment, respectively in perspective (FIG. 4a), the side (FIG. 4b) and the top (FIG. 4c).

### DETAILED DESCRIPTION OF THE PREFERRED EMBODIMENT(S)

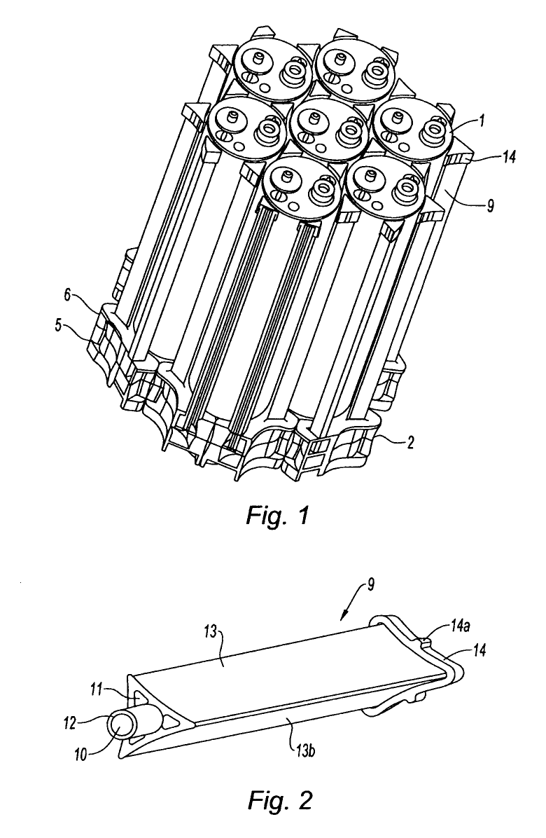

In the description, the terms of positioning in space are taken in reference to the position of the battery shown in FIG. 1. However, the seal of the battery makes it possible to consider its positioning according to a different orientation.

In relation with the figures, hereinbelow are described two embodiments of an electric battery comprising a plurality of elements 1 generating electrical power, in particular the elements 1 can be of an electrochemical nature, for example of the Lithium-ion type. For this, the elements 1 include an enclosure wherein the electrochemical system is confined in order to isolate the chemical components needed for the generation of the electricity. Alternatively, the elements can be supercapacitances.

The battery is more particularly intended to power an electric traction engine of a motor vehicle, either entailing an electric vehicle or a hybrid electric-thermal type. However, the battery according to the invention can also find application for the storage of electrical power in other modes of transport, and in particular in aeronautics. Moreover, in stationary applications such as for wind turbines, the battery according to the invention can also be used advantageously.

The battery comprises a heat and mechanical treatment system of elements 1, said system making it possible on the one hand to treat in temperature the elements 1 and on the other hand to maintain them in a reinforcing structure. As such, the system ensures the electrical safety of the battery with regards to the risks linked to the temperature, the operation of the battery in an optimal temperature range as well as the safety concerning the risks of crash which are inherent with the application in question.

In order to provide the electrical power required, the battery comprises a large number of elements, for example 160 elements distributed into 16 rows of 10 elements. Moreover, the battery can include a pan (not shown), in particular made of plastic, wherein the elements 1 generating electricity and the treatment system are arranged for the installing of said battery in the motor vehicle.

The treatment system comprises a bed 2 of heat treatment fluid and a device for circulating (not shown) said fluid in such a way as to provide for the heat treatment of elements 1. In particular, the device for circulating comprises a pump which makes it possible to pressurise the fluid in a closed circuit, as well as possibly a heat exchanger.

The fluid can be glycol water, and the heat treatment extends for supplying as well as removing calories in such a way as to maintain the elements 1 in an operating temperature range which is optimal. In particular, the treatment system makes it possible to rapidly and effectively ensure the supply or the removal of calories in the battery, in such a way as to unsure the thermal regulation regardless of the conditions of use.

In the embodiments described, the fluid bed 2 comprises two layers 3, 4 separated with fluid which are formed respectively in a housing 5, 6, for example made of moulded plastic material. The housings 5, 6 are associated one with the other in such a way as to form a lower layer 3 and an upper layer 4 wherein the fluid flows separately.

The upper wall of the upper housing 6 comprises receiving locations 7 for the base of a generating element 1, said locations being provided to have the elements 1 on the fluid bed 2 by leaving a lateral separation between the adjacent elements 1. In order to improve the modularity of the battery in relation to the number of elements 1 that are to be used, the housings 5, 6 can be formed of sub-housings which are associated one with the other in order to form the number of locations 7 desired. According to one embodiment, the sub-housings can be positioned in the pan in order to be associated in relation to one another by the structural matrix described hereinafter. Furthermore, the sub-modules can be in fluid communication or be supplied independently with fluid by the intermediary of orifices 5a, 6a.

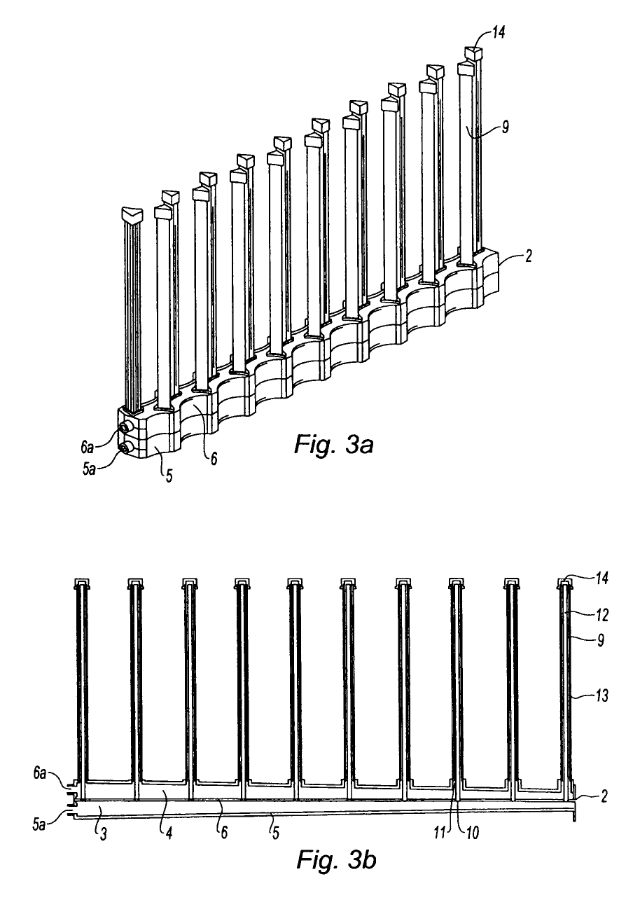

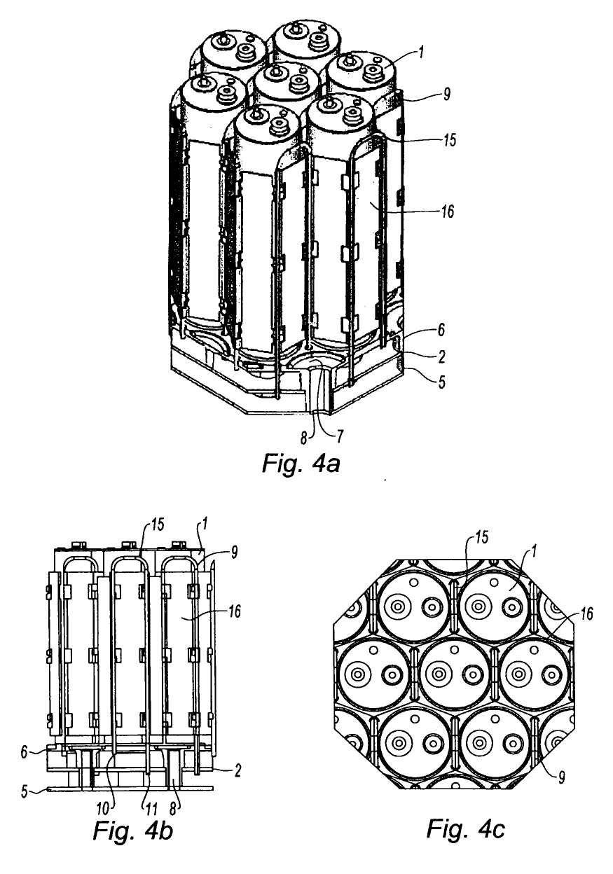

Moreover, the housings 5, 6 are formed in such a way as to leave an orifice exiting 8 across from locations 7, said orifices making possible the sealed association of the housings 5, 6 in relation to one another, by the intermediary of rivets (FIG. 4) or by welding (FIGS. 1 to 3). Furthermore, the exiting orifices 8 make it possible to allow the gases to escape that can be emitted by the elements 1 in the event of decapping of the latter linked to an excessive pressure of elements 1. In this case and when a sealed pan is provided around the battery, the latter is provided with a gas emission valve towards the exterior. Moreover, a humidity or gas emission detector can be added to the battery.

The treatment system further comprises a plurality of heat treatment modules 9 which are each provided with a path of travel of the fluid between an upstream port 10 and a downstream port 11. Each path of travel extends into a lateral separation with the ports 10, 11 in fluid communication with the bed 2. Advantageously, the path of travel has a height that is substantially equal to that of elements 1, in such a way as to ensure the transfer of heat across the totality of the periphery of said element.

In an example of an embodiment, the number of modules 9 can be adapted according to the number of elements 1 used in the battery. For example, the bed 2 and the modules 9 can be manufactured separately with respectively connection sockets and the ports 10, 11, said ports being connected to said sockets during the assembly of said battery, according to whether or not an element in the vicinity is present. As such, the power of the battery can be modulated particularly simply by adjusting the number of elements 1, and this without requiring a modification to the architecture of the battery. Furthermore, the number of locations 7 can be higher than the number of elements 1.

In the embodiments described, the elements 1 have a cylindrical geometry and a compact hexagonal arrangement between them, which makes it possible to optimise the space occupied as well as the mechanical resistance of the battery. The lateral separations formed between these elements 1 therefore also have a cylindrical geometry and a hexagonal arrangement between them. However, in other embodiments that are not shown, the elements can be of different geometry, for example of parallelepiped exterior geometry, and/or have another type of arrangement between them.

The treatment system further comprises a structural matrix (not shown) made of heat conducting and electric insulation polymer resin, said matrix filling the lateral separations by coating at least partially the generating elements 1 and the treatment modules 9. In particular, the matrix coats at least the path of travel.

By structural is meant that the matrix provides the mechanical resistance of elements 1 between them, in particular in relation to the crash test constraints in effect in the automobile industry but also in relation to the other forms of mechanical stress that the battery must undergo in an automobile.

Moreover, the matrix provides a function of heat transfer between the elements 1 and the fluid flowing in the modules 9, as well as an electrical safety function in relation to its electric insulation nature between the elements 1. Concerning transfer of heat, the important characteristic is conductance, which is the ratio between the thermal conductivity of the matrix over its thickness. In an example of an embodiment, the matrix has a thermal conductivity of approximately 1 W/m/° C. and a thickness of approximately 2 mm.

The coating electrically insulates the elements 1 and improves the heat exchanges between said elements and the modules 9, in such a way as in particular to prevent the overheating of said elements. Indeed, the invention in particular makes it possible to not provide a thermally insulating interface between the treatment fluid and the elements 1, and this in an environment that is electrically safe, compact and mechanically resistant.

As for the polymer resin for the matrix, adhesives can be used that have the advantage of increasing the rigidity of the battery and of maintaining the elements 1 in said battery. The adhesives can be for example of the family of epoxies, silicones or acrylics, wherein can be added inorganic components having thermal conductive properties, such as Al₂0₃, AIN, MgO, ZnO, BeO, BN, Si₃N₄, SiC and/or Si0₂. In an example of an embodiment, a bicomponent epoxy resin of the type of that referenced as 2605 by the 3M company can be used.

For its implementation, after the arranging of elements 1 and of modules 9, the fluid resin is arranged in the lateral separations in such a way as to coat said modules as well as said elements, said resin being then solidified in order to form the structural matrix. Consequently, the carrying out of the battery is particularly simple and modulable, by not requiring any specific tooling according to the number of elements 1 to be arranged in said battery.

In order to facilitate the recyclability of the battery, a primary coating, containing a migrating agent, can also be applied to the surface of elements 1. This migrating agent must be able to migrate over one of the connection interfaces in order to generate a layer of low cohesion. This migration is made possible by a thermal activation, which makes it possible to provide for the disassembly of the glued assemblies. This migrating agent can be implemented in a primary, but also in the resin itself. The migrating agent can for example be a polyolefin, or more particularly PTSH (paratoluenesulfohydrazide) which is known for providing the stripping by adding heat as is described in particular in WO-2004/087829.

Furthermore, the matrix can have the properties of a change in phase in a temperature range making it possible to improve the treatment in temperature of the generating elements 1.

In the embodiments shown, the paths of travel are supplied in parallel by the fluid bed 2. As such, the fluid flowing down each path of travel comes directly from the fluid bed 2, without having treated another element 1 beforehand. This then results in an excellent thermal homogeneity by preventing the accumulation of heat linked to a succession of heat exchanges.

For this, the upstream ports 10 are in communication with a layer 3 and the downstream ports 11 are in communication with the other layer 4. As such, a layer 3 is used to supply each module 9 with fluid, and the other layer 4 is used to remove said fluid. In the figures, it can be seen that one of the end portions of the paths of travel crosses the upper layer 4 in order to connect the corresponding port 10 to the lower layer 3.

According to the invention, the excellent homogeneity in temperature in the battery makes it possible to increase the level of balancing between the elements 1 as well as to be able to thermally regulate the battery with a high degree of precision in order to reduce the internal resistances of the elements 1 as much as possible without harming their life span. The optimisation of the thermal management thus makes it possible to increase the energy and the power of the battery, without having to add additional elements.

Furthermore, the treatment system allows for the dissipation of the thermal power coming from the thermal runaway of an element 1, without this excess of heat being transferred to the adjacent elements 1 in a proportion that could lead to a contagion of the thermal runaway phenomenon. This role of thermal confinement makes it possible to avoid the risks of thermal runaways from propagating to the totality of the battery, which is very critical for batteries with high amounts of energy.

In relation with the FIGS. 1 to 3, hereinbelow is described a first embodiment of a battery wherein each treatment module 9 comprises an ascending tube 12 and a body 13 surrounding said tube. Such a module can be carried out by nesting of extruded sections of different forms and lengths, preferentially formed from a good heat conducting material, for example of metal such as aluminium which furthermore has the advantage of a low weight. Note that there is no real constraint concerning the electrical conductivity of the material forming the modules 9, as the latter are coated by an electrically insulated matrix.

The lower end of the tube 12 is protruding axially from the body 13, in such a way as to form the upstream port 10 which is introduced into a corresponding orifice of the lower housing 5. The upper end of said tube exits into the body 13 and, in order to allow for the descent of the fluid, the body 13 is mock in the upper portion and has at least one passage 13a of fluid from the upper end of the tube 12 to the downstream port 11 formed in said body. In particular, the body 13 is force-fitted into an orifice of the upper housing 6, said orifice being provided across from the one wherein the tube 12 is inserted.

In the embodiment shown, the body 13 has a triangular geometry, and forms three channels 13a equally distributed around the tube 12 to exit on the lower wall of said body. This embodiment is adapted for an arrangement wherein each generating element 1 is surrounded by six modules 9 and each of the modules is common to three elements 1.

The lateral surface 13b of the body 13 has an enclosure of geometry analogous to that of the peripheral surface of the elements 1 arranged across from said surface. In the figures, the three lateral surfaces 13b of the body are concave with a radius analogous to that of the elements 1. Furthermore, the body 13 is topped with a cap 14 which has at least one peripheral support zone for the elements. In the figures, a snug 14a is provided on each lateral face of the cap 14. These realisations make it possible to improve the mechanical resistance of elements 1, including before the arranging of the matrix, in order to prevent any contact between said elements.

In relation with the FIG. 4, hereinbelow is described a second embodiment of a battery wherein each treatment module 9 comprises a loop 15 which is formed from a duct having an ascending section and a descending section whereon are respectively provided the upstream 10 and downstream 11 ports, said sections being realised by an upper curved section.

The treatment system further comprises plates 16 made from a heat conductive material, in particular metal like the loops 15, said plates being associated to the sections of loops. More precisely, a plate 16 is arranged in each of the treatment loops 15, between the ascending and descending sections. Moreover, plates 16 are provided to connect the loops 15 between them. In addition to the improvement in the heat transfer, the plates 16 also make it possible to render the battery more rigid. In the figures, each element 1 is surrounded successively by a loop 15, a plate 16, a section of a loop, a plate 16, a loop 15, a plate 16, a section of a loop and a plate 16.

1-14. (canceled)

15. An electric battery comprising a plurality of elements for generating electrical power and a heat and mechanical treatment system for said elements, said system comprising a bed of heat treatment fluid whereon said elements are arranged in such a way as to leave a lateral separation between adjacent ones of the elements, the treatment system further comprising a plurality of heat treatment modules which are each provided with a path of travel of the fluid between an upstream port and a downstream port, each path of travel extending in a lateral separation with the ports in fluid communication with said bed, and said treatment system further comprising a structural matrix made of heat conducting and electric insulation polymer resin with said matrix filling the lateral separations by coating at least partially said generating elements and said treatment modules.

16. The electric battery set forth in claim 15, wherein the matrix has a change in phase properties in a temperature range making it possible to improve the treatment in temperature of the generating elements.

17. The electric battery set forth in claim 15, wherein the paths of travel are supplied in parallel by the bed of fluid.

18. The electric battery set forth in claim 17, wherein the bed of fluid comprises two layers separated with fluid, the upstream port being in communication with a first of said layers and the downstream port being in communication with a second of said other layers.

19. The electric battery set forth in claim 18, wherein the layers are formed respectively in a housing and said housings being associated one on the other, with an end portion of one of the paths of travel crossing the second layer in order to connect the upstream port to the first layer.

20. The electric battery set forth in claim 19, wherein the housings are formed of sub-housings which are associated between them.

21. The electric battery as set forth in claim 18, wherein one of said treatment modules comprises an ascending tube and a body surrounding said ascending tube, a lower end of said ascending tube forming the upstream port and an upper end of said ascending tube exiting into said body, said body being mock in an upper portion and having at least one passage of fluid from the upper end of the tube to the downstream port formed in said body.

22. The electric battery set forth in claim 21, wherein a lateral surface of the body has an enclosure of geometry analogous to that of a peripheral surface of the elements arranged across from said lateral surface.

23. The electric battery set forth in claim 21, wherein the body is topped by a cap and said cap having at least one peripheral support zone for the elements.

24. The electric battery as set forth in claim 18, wherein one of the treatment modules comprises a loop which is formed of a duct having an ascending section and a descending section whereon are respectively provided the upstream and downstream ports, and said sections being connected by an upper curved section.

25. The electric battery set forth in claim 24, wherein the treatment system further comprises plates made of heat conductive material, and said plates being associated with the sections of the loops.

26. The electric battery set forth in claim 25, wherein one of said plates is arranged in each of the treatment loops, between the ascending and descending sections.

27. The electric battery set forth in claim 25, wherein the plates are provided to connect loops between them.

28. The electric battery as set forth in claim 15, wherein the generating elements have a cylindrical geometry and a hexagonal arrangement between them.
